(19) United States
(12) Patent Application Publication
(10) Pub. No.: US 2015/0273632 A1
(43) Pub. Date: Oct. 1, 2015

(54) APPARATUS AND METHOD FOR FORMING THREE-DIMENSIONAL OBJECTS

(71) Applicant: Forelux Inc., Taipei City (TW)

(72) Inventor: Shu-Lu CHEN, Taipei City (TW)

(21) Appl. No.: 14/674,100

(22) Filed: Mar. 31, 2015

Related U.S. Application Data
(60) Provisional application No. 61/973,206, filed on Mar. 31, 2014.

(51) Int. Cl. B23K 26/34

(52) U.S. Cl. CPC B23K 26/345; B33Y 30/00

(57) ABSTRACT

An apparatus for forming a three-dimensional (3D) object includes a first light source unit comprising at least one first light source arranged on a first plane; a second light source unit comprising at least one second light source arranged on a second plane, where the second plane is non-parallel to the first plane; a controller operatively connected to the first light source unit and the second light source unit and configured to control the first light source and the second light source to emit energy beams at predetermined power levels. The energy beams from the first light source and the second light source meet at a place to provide a combined energy sufficient to change a material property of a material at the place.

### CROSS-REFERENCE TO RELATED APPLICATIONS

This patent application claims the benefit of U.S. Provisional Patent Application No. 61/973,206, filed Mar. 31, 2014, which is incorporated by reference herein.

### BACKGROUND

This specification relates to apparatus and methods for forming three-dimensional (3D) objects.

The conventional apparatus for forming three-dimensional objects, such as a selective laser sintering apparatus generally uses single laser to scan layer by layer of material, and the manufacturing efficiency is not satisfactory.

### SUMMARY

According to one innovative aspect of the subject matter described in this disclosure, an apparatus for forming a three-dimensional (3D) object comprises a first light source unit comprising at least one first light source arranged on a first plane; a second light source unit comprising at least one second light source arranged on a second plane, wherein the second plane is non-parallel to the first plane; a main controller operatively connected to the first light source unit and the second light source unit and configured to control the first light source and the second light source to emit energy beams at predetermined power levels; wherein light beams from the first light source and the second light source meet at a cross point with a predetermined unit volume and a combined energy at the cross point is sufficient to change a material property of a raw material within the unit volume for the 3D object.

According to another innovative aspect of the subject matter described in this disclosure, A method for forming a three-dimensional (3D) object, comprises: providing a first light source unit comprising at least one first light source arranged on a first plane; providing a second light source unit comprising at least one second light source arranged on a second plane, wherein the second plane is non-parallel to the first plane; controlling the first light source and the second light source to emit energy beams at predetermined power levels; wherein light beams from the first light source and the second light source meet at a cross point with a predetermined unit volume and a combined energy at the cross point is sufficient to change a material property of a raw material within the unit volume for the 3D object.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

The details of one or more implementations are set forth in the accompanying drawings and the description below. Other potential features and advantages will become apparent from the description, the drawings, and the claims.

### BRIEF DESCRIPTION OF THE DRAWINGS

FIG. 1 is a schematic diagram of one of the implementations for forming a three-dimensional (3D) object with two non-parallel planes.

FIG. 2 shows one application scenario of one of the implementations for forming a three-dimensional (3D) object with two non-parallel planes and multiple light sources.

FIG. 3 is a schematic diagram of one of the implementation for forming a three-dimensional (3D) object with three non-parallel planes.

FIG. 4 shows one application scenario of one of the implementations for forming a three-dimensional (3D) object with three non-parallel planes and multiple light sources.

FIG. 5 shows a schematic diagram of one of the implementations for forming a three-dimensional (3D) object with two non-parallel planes.

FIG. 6 shows a schematic diagram of one of the implementations for forming a three-dimensional (3D) object with three non-parallel planes.

FIG. 7 shows a flowchart for forming a 3D object with the apparatus shown in FIG. 1 to FIG. 6.

### DETAILED DESCRIPTION

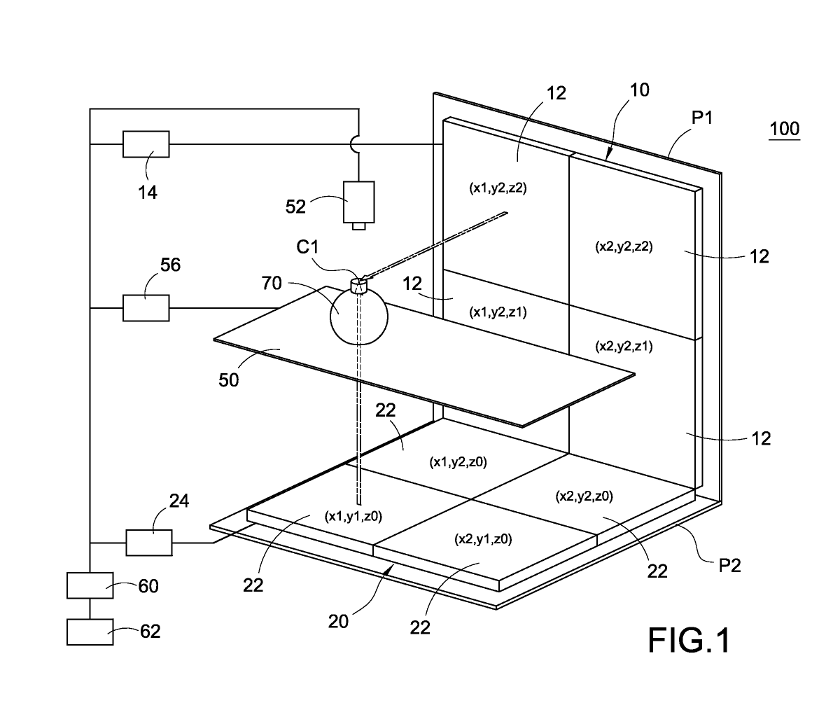

FIG. 1 is a schematic diagram of an example apparatus for forming a three-dimensional (3D) object according to one implementation of this disclosure. The apparatus mainly comprises a first light source unit 10 located on a first plane P1, a second light source unit 20 located on a second plane P2. The first plane P1 and the second P2 are non-parallel to each other, and for example, can be orthogonal to each other to form a 2D Cartesian coordinates. The first light source unit 10 comprises at least one first light source 12, for example, laser 12; and the second source unit 20 comprises at least one second light source 22, for example, lasers 22. One light source unit can include one or multiple light sources to provide a group-control scenario. According to some implementations of this disclosure, the lasers 12 and 22 can be surface emitting lasers such as VCSEL or other types of lasers. In case that the numbers of the first light source 12 and the second light source 22 are plural, multiple light sources 12 and 22 are arranged on the first plane P1 and second plane P2 in a matrix fashion, respectively. The power of each first light source 12 is controlled by a first controller 14 to modulate the emitting light energy level, pulse duration and other parameters; similarly, the power of each second light source 22 is controlled by a second controller 24 to modulate the emitting light energy level, pulse duration and other parameters. According to one implementation of this disclosure, the object 70 to be formed can be placed on a platform 50 moved by a platform actuator 56 to have translational, rotational and tilt movement. According to another implementation of this disclosure, one or multiple first light source 12 can be moved by a first actuator (not shown) and one or multiple second source 22 can be moved by a second actuator (not shown).

As shown in FIG. 1, the first controller 14, the second controller 24 and the platform actuator 56 are operatively connected (for example, wirelessly connected or connected through wires) to a main controller 60. The main controller 60 is operatively connected to a database 62 storing the 3D profile data for the 3D object to be formed. The raw material for the desired 3D object can be supplied to a dispenser 52, which is partially bounded by multiple surfaces/planes P1, P2, wherein multiple light source units 10 and 20 are located on the planes.

The raw material property, such as its phase (for example, solid, liquid or gas phase), chemical bonding, molecular structure and mechanical strength, can be changed by the energy that the light sources 12 and 22 provide at their cross-point. The power and the duration of the pulse of the light sources 12 and 22 can be tuned to fit the desired energy level to cause the raw material to change its property. For example, the raw material can be preheated, melted, fused or annealed by the energy of combined light beams at their cross-point. The beam spot size of the light sources 12 and 22 can be tuned to provide a predetermined unit volume at the cross point. The predetermined unit volume can be correlated to the desired spatial resolution of this 3D object, and can be determined by the power and spot size of the light source, the optical property of the medium the beam travels, and their interactions. After the material property is changed, a “developing” process, if necessary, can be applied to separate these “energy treated” parts of the material with the rest parts which do not absorb enough energy. A desired 3D object can then be formed. More particularly, this apparatus for forming a 3D object can be implemented as an additive manufacturing device capable of constructing 3D structures by selectively fusing regions of the raw material. For example, the laser beams from the light sources 12 and 22 are crossed-over at point C1 shown in FIG. 1 to fuse a unit volume of the raw material there, where the raw material can be metered from the dispenser 52 with specific weight and/or volume. Those fused material can have stronger bonding and can maintain its form when treated with another chemical solution, while the non-fused parts are washed away. On the other hand, this apparatus for forming a 3D object can also be implemented as a subtractive manufacturing device capable of constructing 3D structures by selectively melting regions of raw material. For example, the laser beams from the light sources 12 and 22 are crossed-over at point C1 shown in FIG. 1 to melt a unit volume of raw material there and a subsequent wash-away developing process is conducted to remove the melted material.

As an example, a raw material with its melting point below, for example 500° C., is used and the first light sources 12 and the second light sources 22 are VCSELs with spot size corresponded to an unit volume similar to the spatial resolution of the 3D object to be formed. For example, the spot size of the VCSEL 12 and 22 is 10 um if the desired spatial resolution for the 3D object is also around 10 um. Alternatively, if the desired spatial resolution of the 3D object is around 10 um, the unit volume formed by the lasers at their cross-point can be larger or less than 10 um if conditions such as the refractive index and the thermal conduction coefficient of the raw material and the distance the beam travels (for example, around the focal length or not) are taken into account. The main controller 60 can control the power levels of the laser beams from the VCSEL 12 and 22 so that the temperature only reaches 500° C. within an unit volume when two laser beams cross-over, such as point C1 in FIG. 1. The remaining part of the raw material which only passed by one laser beam within a certain time interval will not be melted since the power level is not high enough to reach 500° C.

To start a manufacturing process, the raw material is put into a dispenser 52 and is at least partially surrounded by multiple planes with multiple light source units on them. The main controller 60 can fetch the blueprint of the desired 3D object, wherein this 3D object blueprint can be divided into several small unit volumes. The exact size of the unit volume depends on combinations of criteria, including the available laser spot size, the material grain size, the material refractive index, the material thermal properties, and the targeted spatial resolution of the 3D object. After the 3D object is divided into individual small unit volume and then recorded and transformed into a 3D profile data (3D profile file), this 3D profile data for this 3D object, containing the location information (x,y,z) of each individual unit volume, can be used by the main controller 60 to control the light source units at various location (x,y,z). For example, if the location (x1, y1, z2) is intended to receive the energy from laser beams, the main controller 60 controls the platform actuator 56 to move the platform 50 or to move the dispenser 52 such that at least part of the material is placed at the location C1 (x1, y1, z2). Afterward, the light source 12 at (x1, y2, z2) of the first plane P1 and the light source 22 at (x1, y1, z0) of the second plane P2 can be turned on, and their cross-point indicates the part where the unit volume receives energy from combined laser beams and is melted there. By sequentially or simultaneously performing the above process with massive number of laser units, an object with a prescribed 3D geometry can be formed efficiently. Besides the above-mentioned melting operation, a combination of the target material properties and the power level of the light source 12, 22 can be chosen so that the energy at the cross point C1 can preheat, fuse and/or anneal the material at the cross-point C1. Moreover, even not particularly shown in FIG. 1, the platform 50 can be mover/rotated/tilted by the platform actuator 56 such that the platform 50 is not at the propagation path of any light source 12, 22. Alternatively, the platform 50 can be made of material transparent to light emitted from the light source 12, 22. Alternatively, the emitted power of the light sources 12, 22 is such manipulated that the energy at the cross-point can still achieve desired energy level even after propagation loss and attenuation.

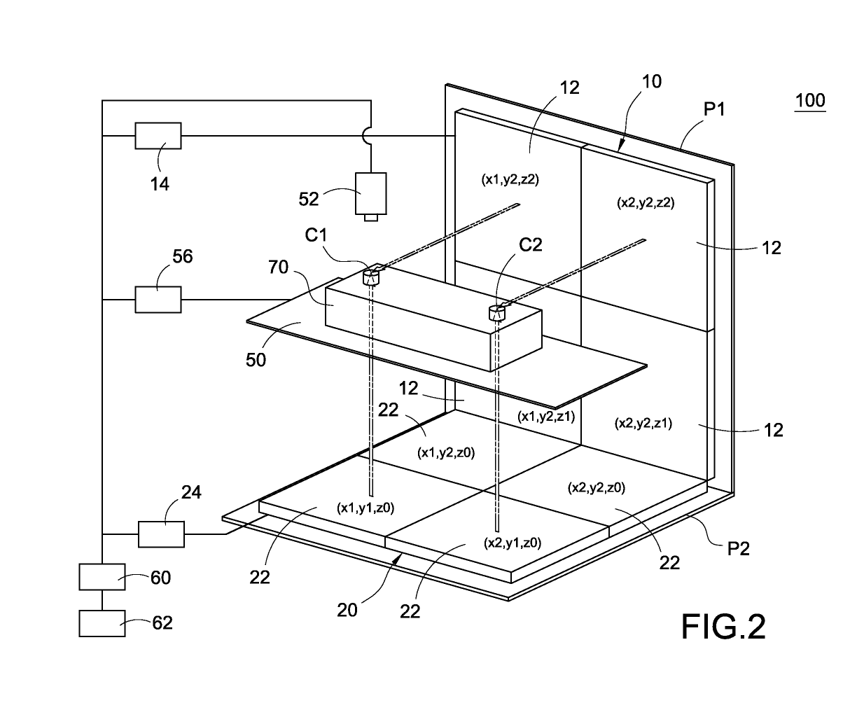

FIG. 2 shows one application scenario according to FIG. 1. This scenario describes the case that multiple light sources on each plane are simultaneously turned on to form multiple cross-points, such as C1 and C2, for fast throughput. More particularly, the light source 12 at location (x1,y2,z2) on the first plane P1 and the light source 22 at location (x1,y1,z0) on the second plane P2 are simultaneously turned on to locate a first unit volume at cross-point C1 (x1, y1, z2). The light source 12 at location (x2,y2,z2) on the first plane P1 and the light source 22 at location (x2,y1,z0) on the second plane P2 are simultaneously turned on to locate a second unit volume at cross-point C2 (x2, y1, z1). Multiple lasers are turned on to change the material property of multiple unit volumes for parallel manufacturing process. In another scenario, the light source 12 at location (x1,y2,z2) on the first plane P1 and the light source 22 at location (x1,y1,z0) on the second plane P2 are first turned on with higher power level to melt the unit volume of material at cross-point C1. Then the platform 50 move the 3D object such that the melted material at location C1 is moved to the location C2 and then the light source 12 at location (x2,y2,z2) on the first plane P1 and the light source 22 at location (x2,y1,z0) on the second plane P2 are simultaneously turned on with lower power level to anneal the melted material. At the same time, the light source 12 at location (x1,y2,z2) on the first plane P1 and the light source 22 at location (x1,y1,z0) on the second plane P2 are still turned on with the higher power level to melt the unit volume of material at cross-point C1. With this example, the 3D object can be formed by providing different laser powers at different cross points for more versatile manufacture process. For simple illustration purpose, only one light source unit is shown for one specific plane, and only one 2×2 array of light sources are shown for one light source unit. In real implementation, there can be multiple light source units at the same plane, and multiple light sources within a light source unit. There are many possible arrangements for the light sources, for example, the light sources can be arranged in a circular or matrix form, and there can be more than thousands of light source (lasers) within a single light source unit for finer power level control, emission direction adjustment, achieving finer spatial resolution and higher forming throughput.

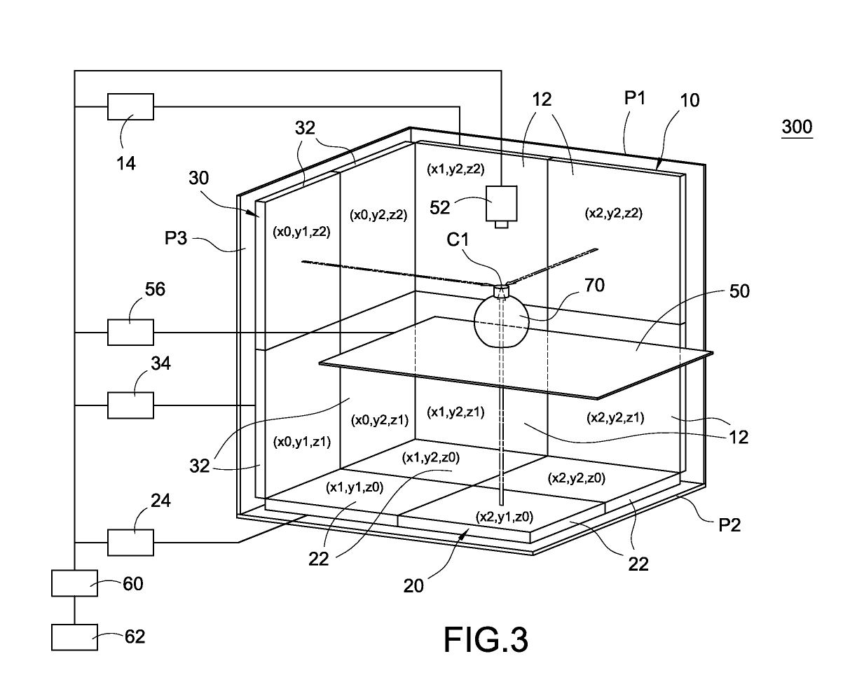

FIG. 3 is an example of another implementation for forming a three-dimensional (3D) object with three non-parallel planes. The apparatus mainly comprises a first light source unit 10 located on a first plane P1, a second light source unit 20 located on a second plane P2, and a third light source unit 30 located on a third plane P3. The first plane P1, the second plane P2 and the third plane P3 are non-parallel to each other, and for example, can be orthogonal to each other to form a 3D Cartesian coordinates. Similar to the example shown in FIG. 1, the first light source unit 10 comprises at least one first light source 12, the second source unit 20 comprises at least one light source 22, and the third light source unit 30 comprises at least one light source 32. According to some implementations of this disclosure, the light source 12, 22 and 32 can be surface emitting lasers such as VCSELs. As shown in FIG. 3, the plurality of light sources 12, 22, 32 are arranged on the planes P1, P2 and P3 in a matrix form, respectively. The power of each light source unit 10, 20 and 30 is controlled by a first controller 14, a second controller 24 and a third power controller 34, and the light source unit can further deliver the control information to the light source 12,22,32. According to one implementation of this disclosure, the object to be formed can be placed on a platform 50 controlled by a platform actuator 56 to have rotational, translational, and tilting movement. According to another implementation of this disclosure, the first light source unit 10 can be moved by a first actuator (not shown), the second light source 20 can be moved by a second actuator (not shown), and the third light source 30 can be moved by a third actuator (not shown).

Similar to the process described before, the raw material is put into a dispenser 52 and is at least partially surrounded by multiple planes with multiple light source units on them. The main controller 60 can fetch the blueprint of the desired 3D object, wherein this 3D object blueprint can be divided into several small unit volumes. The exact size of the unit volume depends on combinations of criteria, including the available laser spot size, the material grain size, the material refractive index, the material thermal properties, and the targeted spatial resolution of the 3D object. After the 3D object is divided into individual small unit volume and then recorded and transformed into a 3D profile data (3D profile file), this 3D profile data for this 3D object, containing the location information (x,y,z) of each individual unit volume, can be used by the main controller 60 to control the light source units at various location (x,y,z). For example, if the location (x1, y1, z2) is intended to receive the energy from laser beams, the main controller 60 controls the platform actuator 56 to move the platform 50 or to move the dispenser 52 such that at least part of the material is placed at the location C1 (x1, y1, z2).

Afterward, the light source 12 at (x1, y2, z2) of the first plane P1, the light source 22 at (x1, y1, z0) of the second plane P2, and the light source 32 at (x0, y1, z2) of the third plane P3 can be turned on, and their cross-point indicates the part where the unit volume receives energy from combined laser beams and is melted there. By sequentially or simultaneously performing the above process with massive number of laser units, an object with a prescribed 3D geometry can be formed efficiently. Besides the above-mentioned melting operation, a combination of the target material properties and the power level of the light source 12, 22,32 can be chosen so that the energy at the cross point C1 can preheat, fuse and/or anneal the material at the cross-point C1. Moreover, even not particularly shown in FIG. 1, the platform 50 can be mover/rotated/tilted by the platform actuator 56 such that the platform 50 is not at the propagation path of any light source 12, 22, 32. Alternatively, the platform 50 can be made of material transparent to light emitted from the light source 12, 22, 32. Alternatively, the emitted power of the light sources 12, 22, 32 is such manipulated that the energy at the cross-point can still achieve desired energy level even after propagation loss and attenuation. The remaining part of the raw material which only passed by one laser beam or two laser beams will not undergo transformation since the energy level is not high enough.

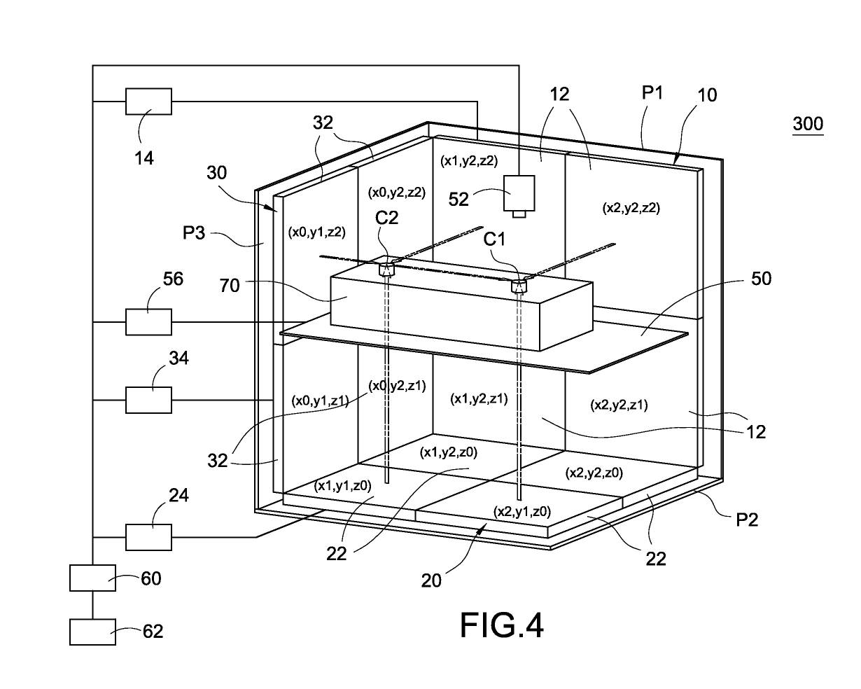

FIG. 4 shows another application scenario according to the implementation shown in FIG. 3. In this scenario, multiple light sources on each plane can be simultaneously turned on to have multiple cross-points C1 and C2 for fast throughput. More particularly, the light source 12 at location (x2,y2,z2) on the first plane P1, the light source 22 at location (x2,y1,z0) on the second plane P2 and the light source 32 at location (x0,y1,z2) on the first plane P3 are simultaneously turned on to locate a first unit volume at cross-point C1 (x2, y1, z2). In addition, the light source 12 at location (x1,y2,z2) on the first plane P1, the light source 22 at location (x1,y1,z0) on the second plane P2 and the light source 32 at location (x0,y1,z2) on the third plane P3 are simultaneously turned on to locate a second unit volume at cross-point C2 (x1, y1, z2). Multiple lasers are turned on to change the material property of multiple unit volumes inside the raw material for parallel manufacturing/forming process. In another scenario, the light source 12 at location (x2,y2,z2) on the first plane P1, the light source 22 at location (x2,y1,z0) on the second plane P2 and the light source 32 at location (x0,y1,z2) on the first plane P3 are first turned on with lower power level to pre-heat the unit volume of material at cross-point C1. Then the platform 50 move the 3D object such that the preheated material at location C1 is moved to the location C2 and then the light source 12 at location (x1,y2,z2) on the first plane P1, the light source 22 at location (x1,y1,z0) on the second plane P2 and the light source 32 at location (x0,y1,z2) on the third plane P3 are simultaneously turned on with higher power level to melt the material at location C2. At the same time, the light source 12 at location (x1,y2,z2) on the first plane P1, the light source 22 at location (x1,y1,z0) on the second plane P2, and the light source 32 at location (x0,y1,z2) are still turned on with the lower power level to preheat the unit volume of material at cross-point C1. In this example, the 3D object can be formed by providing different power levels at different cross-points for more versatile manufacture process. For simple illustration purpose, only one light source unit is shown for one specific plane, and only one 2×2 array of light sources are shown for one light source unit. In real implementation, there can be multiple light source units at the same plane, and multiple light sources within a light source unit. There are many possible arrangements for the light sources, for example, the light sources can be arranged in a circular or matrix form, and there can be more than thousands of light source (lasers) within a single light source unit for finer power level control, emission direction adjustment, achieving finer spatial resolution and higher forming throughput.

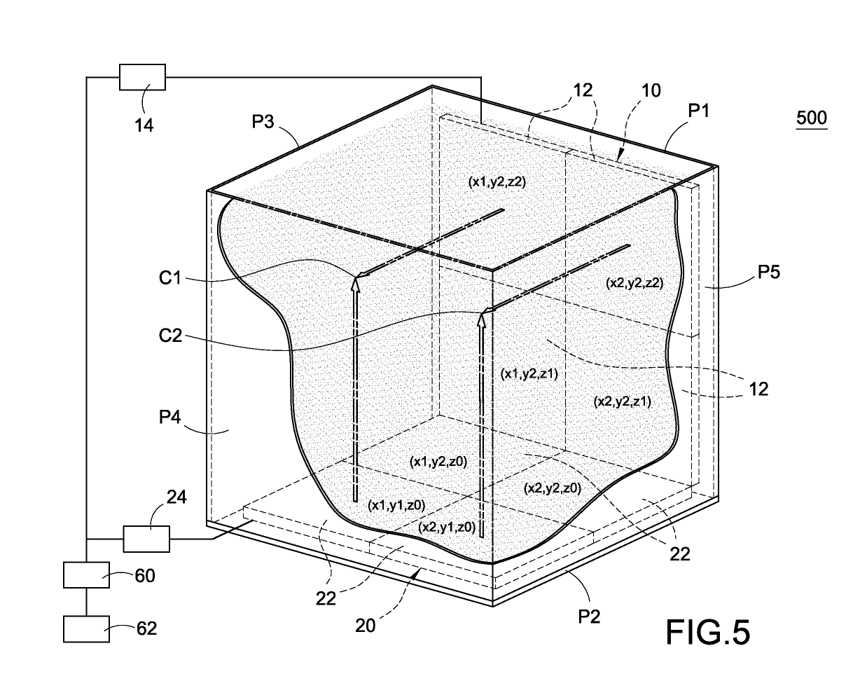

FIG. 5 shows another schematic example for forming a three-dimensional (3D) object according to one implementation of this disclosure. This apparatus is similar to that shown in FIG. 1 and a container is shown to accommodate raw material for the 3D object bounded by the first plane P1 and the second plane P2, both planes have a plurality of light sources 12 and 22. The side of the container is transparent to the energy beams emitted from the light sources, and the platform and dispenser to contain, add, and move the raw material as depicted in FIG. 1 can be optional. For example, if the target 3D object requires only one type of raw material, there can be no platform to move the raw material since all the raw material can be put into the container at once.

As another example, if the target 3D object requires multiple raw materials for different part of it, a dispenser or platform as depicted in FIG. 1 could be used to add or move a different type of raw material for different part of this 3D object. The raw material depicted as a dashed portion in the container is first put into the container partially surrounded by the first plane P1 and the second plane P2 either directly or indirectly (separate by at least one extra medium).

In one of the manufacturing scenario, the light source 12 at location (x1,y2,z2) on the first plane P1 and the light source 22 at location (x1,y1,z0) on the second plane P2 are simultaneously turned on to locate a first unit volume at cross-point C1 (x1, y1, z2). The light source 12 at location (x2,y2,z2) on the first plane P1 and the light source 22 at location (x2,y1,z0) on the second plane P2 are simultaneously turned on to locate a second unit volume at cross-point C2 (x2, y1, z2). Multiple lasers can be turned on to change the material property of multiple unit volumes for parallel manufacturing/forming process. Moreover, the plane P4 opposite to the first plane P1 can be a reflective, partially-reflective or totally-transmissive surface to render more controllability to the combined energy.

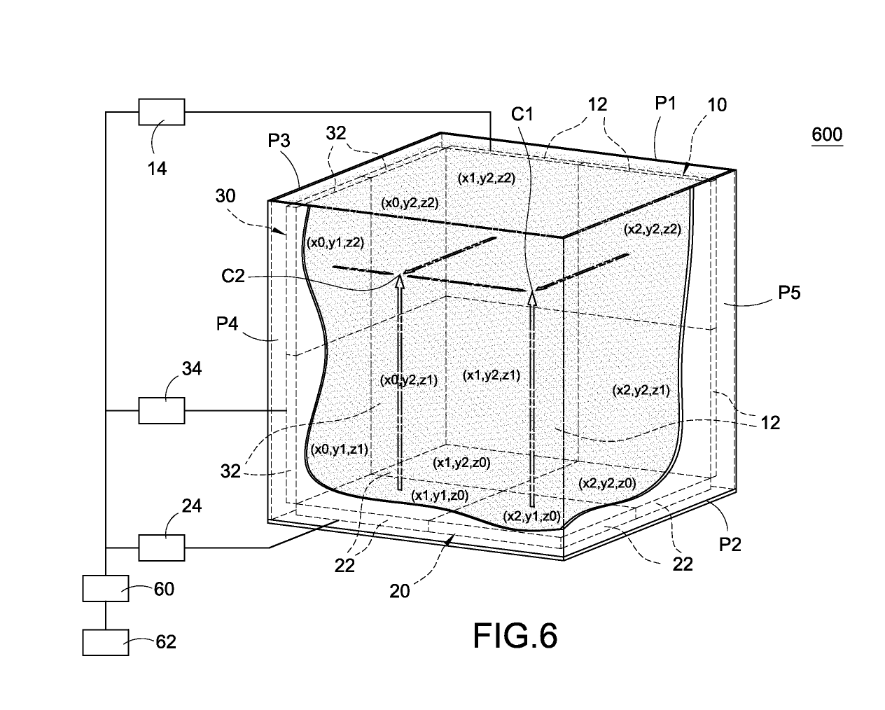

FIG. 6 shows a schematic example for forming a three-dimensional (3D) object according to one implementation of this disclosure. This apparatus is similar to that shown in FIG. 3 and a container is shown to accommodate raw material for the 3D object bounded by the first plane P1, the second plane P2 and the third plane P3, all planes have a plurality of light sources units 10, 20, 30. The side of the container is transparent to the energy beams emitted from the light sources, and the platform and dispenser to contain, add, and move the raw material as depicted in FIG. 3 can be optional. For example, if the target 3D object requires only one type of raw material, there can be no platform to move the raw material since all the raw material can be put into the container at once.

As another example, if the target 3D object requires multiple raw materials at different part of it, a dispenser or platform as depicted in FIG. 3 could be used to add or move a different type of raw material for different part of this 3D object. The raw material depicted as a dashed portion in the container is first put into the container and partially surrounded by the first plane P1, the second plane P2 and the third plane P3 either directly or indirectly (separate by at least one extra medium).

In a manufacture scenario, the light source 12 at location (x2,y2,z2) on the first plane P1, the light source 22 at location (x2,y1,z0) on the second plane P2 and the light source 32 at location (x0,y1,z2) on the first plane P3 are simultaneously turned on to locate a first unit volume at cross point C1 (x2, y1, z2). In additional, the light source 12 at location (x1,y2,z2) on the first plane P1, the light source 22 at location (x1,y1,z0) on the second plane P2 and the light source 32 at location (x0,y1,z2) on the third plane P3 are simultaneously turned on to locate a second unit volume at cross point C2 (x1, y1, z2). Multiple lasers are turned on to change the material property of multiple unit volumes for parallel manufacturing/forming process. Moreover, the plane P4 opposite to the first plane P1 can be a reflective face, partially-reflective face or totally-transmissive face to render more controllability to the combined energy. Similarly, the plane P5 opposite to the third plane P3 can be a reflective face, partially-reflective face or totally-transmissive face to render more controllability to the combined energy.

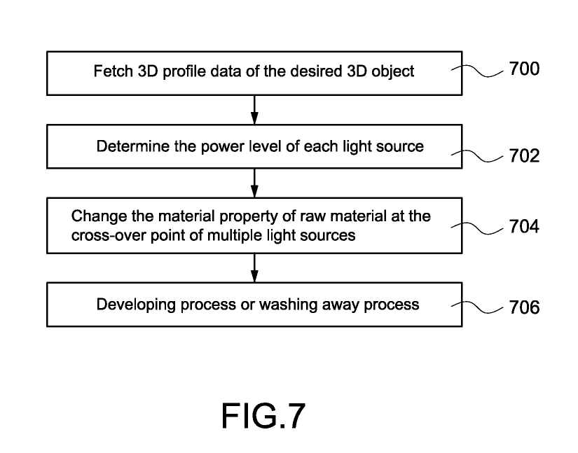

FIG. 7 shows an exemplary flowchart for forming a 3D object according to this disclosure. First the main controller 60 fetches 3D profile data of the desired 3D object from the database 62 (700). The main controller 60 then determines the power level of each light sources 12, 22 (32) according the material property to be changed and the raw material used (702). The main controller 60 controls the light sources 12, 22 (32) to emit energy beams of desired power and the energy beams have multiple cross-points with certain unit volumes, wherein the material property within multiple unit volumes is changed (704) simultaneously for high throughput forming process. Optionally, a developing process or washing away can be conducted (706).

Major features of this disclosure for manufacturing 3D objects including: precise 3D positioning using cross-over of multiple energy beams; tunable beam spot size and power to fit multiple raw materials properties; high throughput, parallel process to manufacture a 3D object by turning on large number of electromagnetic-wave-emitting units in the arrays to locate multiple spatial unit volumes. Also note that material properties other than melting point (for example: crystal structure, lattice constant) can also be used to separate the wanted and unwanted part of the 3D object. Furthermore, the planes used to define the spatial location are based on “Cartesian coordinate” system for easy illustrative purpose. Other coordinate system, such as a “Cylindrical coordinate” system, can also be used as long as the coordinate system can be used to locate a spatial location by corresponding light source arrangements. It should be understood that the examples and figures are for illustrative purpose only, are not drawn to scale, and should not be regarded as limiting the scope of this disclosure. Other variations, as long as utilizing the concept of this disclosure, should be viewed as being covered by this disclosure.

Embodiments and all of the functional operations described in this specification may be implemented in digital electronic circuitry, or in computer software, firmware, or hardware, including the structures disclosed in this specification and their structural equivalents, or in combinations of one or more of them. Embodiments may be implemented as one or more computer program products, i.e., one or more modules of computer program instructions encoded on a computer-readable medium for execution by, or to control the operation of, data processing apparatus. The computer readable-medium may be a machine-readable storage device, a machine-readable storage substrate, a memory device, a composition of matter affecting a machine-readable propagated signal, or a combination of one or more of them. The computer-readable medium may be a non-transitory computer-readable medium. The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any form of programming language, including compiled or interpreted languages, and it may be deployed in any form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory may be supplemented by, or incorporated in, special purpose logic circuitry.

To provide for interaction with a user, embodiments may be implemented on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Embodiments may be implemented in a computing system that includes a back end component, e.g., as a data server, or that includes a middleware component, e.g., an application server, or that includes a front end component, e.g., a client computer having a graphical user interface or a Web browser through which a user may interact with an implementation of the techniques disclosed, or any combination of one or more such back end, middleware, or front end components. The components of the system may be interconnected by any form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations, but rather as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Thus, particular embodiments have been described. Other embodiments are within the scope of the following claims. For example, the actions recited in the claims may be performed in a different order and still achieve desirable results. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

What is claimed is:

1. An apparatus for forming a three-dimensional (3D) object, comprising:
a first light source and a second light source arranged on a first plane;
a third light source and a fourth light source arranged on a second plane non-parallel to the first plane;
a controller configured to control the first light source, the second light source, the third light source and the fourth light source to emit energy beams;
wherein the energy beams from the first light source and the third light source meet at first place to provide a combined energy sufficient to change a material property of a material at the first place.

2. The apparatus in claim 1, wherein the combined energy at the first place is sufficient to preheat, melt, fuse or anneal the first material at the first place.

3. The apparatus in claim 1, wherein the first plane is orthogonal to the second plane.

4. The apparatus in claim 1, wherein the energy beams from the second light source and the fourth light source meet at second place to provide a combined energy sufficient to change a material property of a material at the second place.

5. The apparatus in claim 1, further includes a fifth light source arranged on a third plane non-parallel to the first plane and the second plane.

6. The apparatus in claim 5, wherein the energy beams from the fifth light source and the second light source meet at third place to provide a combined energy sufficient to change a material property of a material at the third place.

7. The apparatus in claim 5, wherein the first plane, the second plane and the third plane are orthogonal to each other to form a three-dimensional Cartesian coordinate system.

8. The apparatus in claim 1, further comprising a dispenser configured to provide the material at the first place.

9. The apparatus in claim 4, further comprising a dispenser configured to provide a material at the first place and to provide a material at the second place wherein the material at the first place is different with the material at the second place.

10. A method for forming a three-dimensional (3D) object, comprising:
providing a first material placed in a space partially surrounded by a first plane and a second plane non-parallel to the first plane;
providing a first light source and a second light source arranged on the first plane;
providing a third light source and a fourth light source arranged on the second plane;
controlling the first light source, the second light source, the third light source and the fourth light source to emit energy beams;
wherein the energy beams from the first light source and the third light source meet at first place to provide a combined energy sufficient to change a material property of the first material at the first place.

11. The method in claim 10, wherein the first light source is controlled to emit energy beam at a first power level the second light source is controlled to emit energy beam at a second power level higher than the first power level.

12. The method in claim 10, wherein the energy beams from the second light source and the fourth light source meet at second place to provide a combined energy sufficient to change a material property of a second material at the second place.

13. The method in claim 10, further includes providing a fifth light source arranged on a third plane non-parallel to the first plane and the second plane.

14. The method in claim 13, wherein the first plane, the second plane and the third plane are orthogonal to each other to form a three-dimensional Cartesian coordinate system.

15. The method in claim 12, further includes providing a dispenser configured to provide a first material at the first place and a second material at the second place.
